(19) United States
(12) Patent Application Publication
(10) Pub. No.: US 2006/0038140 A1
(43) Pub. Date: Feb. 23, 2006

(54) Protective item for firefighter or for emergency rescue worker and opaque to hazardous radiation

(75) Inventors: William L. Grilliot, Dayton, OH (US); Mary I. Grilliot, Dayton, OH (US); Jeffrey O. Stull, Austin, TX (US)

Correspondence Address: WOOD, PHILLIPS, KATZ, CLARK & MORTIMER, 500 W. MADISON STREET, SUITE 3800, CHICAGO, IL, 60661, US

(73) Assignee: Morning Pride Manufacturing, L.L.C.

(21) Appl. No.: 11/254,361

(22) Filed: Oct. 20, 2005

Related U.S. Application Data
(63) Continuation-in-part of application No. 10/985,464, filed on Nov. 10, 2004.
Application No. 10/985,464 is a continuation of application No. 10/358,928, filed on Feb. 5, 2003, now Pat. No. 6,940,082.

(51) Int. Cl. G21F 3/02

(52) U.S. Cl. 250/516.1

(57) ABSTRACT

A protective item for a firefighter or for an emergency rescue worker has an outer shell, which is opaque to hazardous radiation, and an inner liner, which has an outer layer providing a moisture and chemical barrier and an inner layer providing thermal insulation. The protective item may be a protective garment, such as a protective coat, protective trousers, protective overalls, or protective coveralls, a protective glove, or an item of protective footwear, such as a protective boot.

### CROSS-REFERENCE TO RELATED APPLICATIONS

This application is a continuation-in-part of U.S. patent application Ser. No. 10/985,464, which was filed on Nov. 10, 2004, as a continuation of U.S. patent application Ser. No. 10/358,928, which was filed on Feb. 5, 2003, and from which U.S. Pat. No. 6,940,082 B2 issued on Sep. 6, 2005. The disclosure of U.S. Pat. No. 6,940,082 B2 is incorporated herein by reference.

### TECHNICAL FIELD OF THE INVENTION

This invention pertains to a protective item, such as a protective garment, an item of protective footwear, or a protective glove, for a firefighter or for an emergency rescue worker. This invention contemplates that the protective item is opaque to hazardous radiation.

### BACKGROUND OF THE INVENTION

Commonly, whether civilian or military, a firefighter or an emergency rescue worker wears various protective items, such as protective garments, protective footwear, and protective gloves. Here, protective garments may include a protective coat, protective trousers, protective overalls, or protective coveralls and protective footwear may include protective boots. Commonly, each protective item has an outer shell and an inner liner, which may have plural layers, such as a layer providing a moisture barrier and a layer providing thermal insulation.

As exemplified in U.S. Pat. No. 6,281,515 and No. 6,459,091, the disclosures of which are incorporated herein by reference, and in United States Patent Application Publications No. US 2003/0010939 A1 and No. US 2004/0004196 A1, the disclosures of which are incorporated herein by reference, lightweight materials have been developed, from which lightweight garments, lightweight blankets, and lightweight tents can be made and which are opaque to hazardous radiation, such as x-rays. Those materials are described in those disclosures as being radiopaque.

### SUMMARY OF THE INVENTION

This invention provides a protective item for a firefighter or for an emergency rescue worker. The protective item has an outer shell and an inner liner. The outer shell is opaque to hazardous radiation. Preferably, the inner layer has an outer layer providing a moisture and chemical barrier and an inner layer providing thermal insulation.

The protective item may be a protective garment, such as a protective coat, protective trousers, protective overalls, or protective coveralls. The protective item may be a protective glove. The protective item may be an item of protective footwear, such as a protective boot.

### BRIEF DESCRIPTION OF THE DRAWINGS

FIG. 1 is a perspective view of a protective coat for a firefighter, as an example of a protective item embodying this invention.

FIG. 2 is a perspective view of the protective coat, as opened to show that the protective coat has an outer shell and an inner liner.

FIG. 3 is a sectional view of the inner liner, as taken along line 3—3 of FIG. 1, in a direction indicated by arrows.

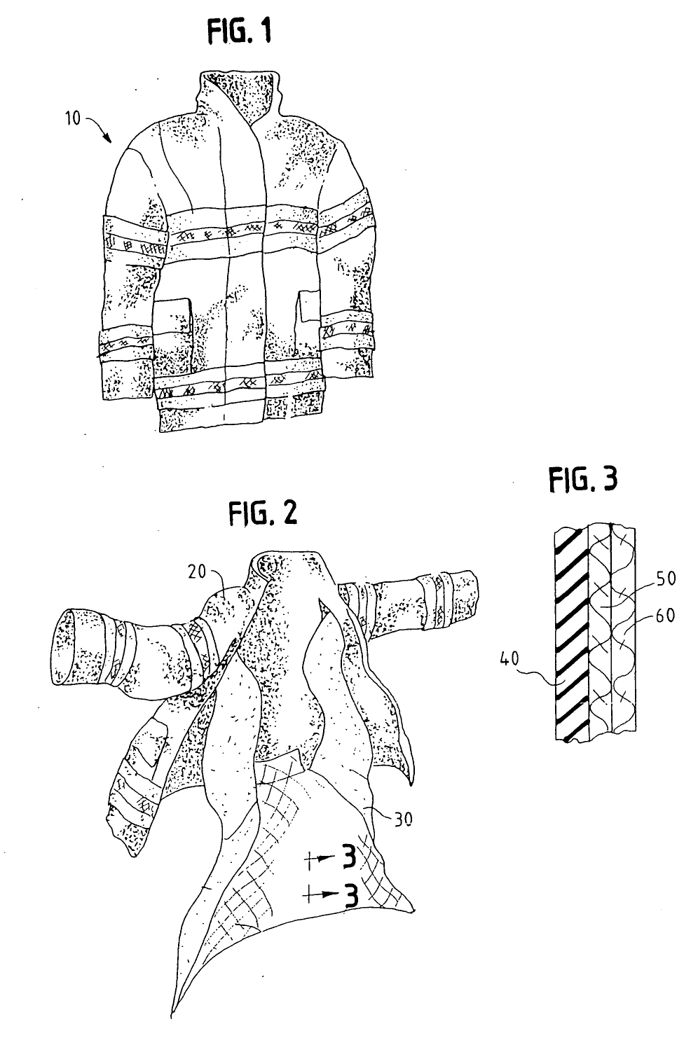

### DETAILED DESCRIPTION OF THE ILLUSTRATED EMBODIMENT

As illustrated, a protective coat 10 for a firefighter exemplifies a protective item embodying this invention. As contemplated by this invention, the protective coat 10 is opaque to hazardous radiation. The protective coat 10 has an outer shell 20, which conforms to National Fire Protection Association (NFPA) standards for outer shells for protective garments for firefighters, and an inner liner 30, which conforms to National Fire Protection Association (NFPA) standards for inner liners for protective garments for firefighters and which is opaque to hazardous radiation.

The inner liner 30 has an outer layer 40, which provides a moisture and chemical barrier, an intermediate layer 50, which provides thermal insulation, and an inner layer 60, which is opaque to hazardous radiation. The outer layer 40 and the intermediate layer 50 are conventional in inner liners for protective garments for firefighters.

Preferably, the inner layer 60 is made from one of the materials described as radiopaque in U.S. Pat. No. 6,281,515 and No. 6,459,091 and United States Patent Application Publications No. US 2003/0010939 A1 and No. US 2004/0004196 A1, supra.

Alternatively, the outer layer 20 is made from or has laminated, bonded, or sewn thereto, either to its inner surface, which is preferable, or to its outer surface, one of the materials described as radiopaque in U.S. Pat. No. 6,281,515 and No. 6,459,091 and United States Patent Application Publications No. US 2003/0010939 A1 and No. US 2004/0004196 A1, supra.

Alternatively, the inner layer 60 is omitted and one of the materials described as radiopaque in U.S. Pat. No. 6,281,515 and No. 6,459,091 and United States Patent Application Publication No. US 2003/0010939 A1 and No. US 2004/0004196 A1, supra, is used as one of the materials of the layer 40 providing a moisture and chemical barrier and/or as one of the materials of the layer 50 providing thermal insulation.

Rather than in the protective coat 10, this invention may be also embodied in protective garments of other types, such trousers, overalls, or coveralls, in protective footwear, such as boots, or in protective gloves. When this invention is embodied in an item of protective footwear, such as a boot, or in a protective glove, the outer shell may be a leather, rubber, or fabric shell.

1. A protective item for a firefighter or for an emergency rescue worker, the protective item having an outer shell and an inner liner, wherein the outer shell is opaque to hazardous radiation.

2. The protective item of claim 1 wherein the inner liner has plural layers, one of which provides a moisture and chemical barrier and another of which provides thermal insulation.

3. The protective item of claim 1 wherein the inner liner has plural layers, an outer one of which provides a moisture and chemical barrier and an inner one of which provides thermal insulation.

4. The protective item of claim 1, 2, or 3, which is a protective garment, such as a protective coat, protective trousers, protective overalls, or protective coveralls.

5. The protective item of claim 1, 2, or 3, which is a protective glove.

7. The protective item of claim 1, 2, or 3, which is an item of protective footwear.
